(19) United States
(12) Patent Application Publication
(10) Pub. No.: US 2012/0144922 A1
(43) Pub. Date: Jun. 14, 2012

(54) PISTON-CHAMBER COMBINATION

(75) Inventor: Nicolaas van der Blom, Reading (GB)

(73) Assignee: NVB INTERNATIONAL UK LTD., Reading (GB)

(21) Appl. No.: 13/142,688

(22) PCT Filed: Dec. 30, 2009
(86) PCT No.: PCT/EP2009/009352

§ 371 Date: Feb. 27, 2012

(30) Foreign Application Priority Data
Dec. 30, 2008 (CL) 3934-2008
Dec. 30, 2008 (EP) PCT/EP2008/011175

(51) Int. Cl. F04B 53/14; F16F 9/24; F15B 13/04; G01L 7/16

(52) U.S. Cl. 73/744; 92/249; 188/297; 91/422

(57) ABSTRACT

A piston chamber combination comprising a container type piston, communicating with an enclosed space, said enclosed space having an at least substantially constant volume.

### TECHNICAL FIELD

A piston-chamber combination comprising an elongate chamber which is bounded by an inner chamber wall and comprising a piston means in said chamber to be sealingly movable relative to said chamber at least between first and second longitudinal positions of said chamber, said chamber having cross-sections of different cross-sectional areas at the first and second longitudinal positions of said chamber and at least substantially continuously differing cross-sectional areas at intermediate longitudinal positions between the first and second longitudinal positions thereof, the cross-sectional area at the first longitudinal position being larger than the cross-sectional area at the second longitudinal position, said piston means being designed to adapt itself and said sealing means to said different cross-sectional areas of said chamber during the relative movements of said piston means from the first longitudinal position through said intermediate longitudinal positions to the second longitudinal position of said chamber, wherein the piston means comprises an elastically deformable container comprising a deformable material, wherein the piston means comprises an enclosed space communicating with the deformable container.

### BACKGROUND OF THE INVENTION

EP 1179140 B1 discloses a piston chamber combination which comprises a container type piston, which is elastically deformable, communicating with an enclosed space 125. Said space has a variable volume. In small constructions may it be not possible to ‘squeeze in’ functions which make the variability of said volume possible, and additionally may such constructions be expensive, in order to make these reliable.

EP 1384004 B1 discloses a container type piston wherein the piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the piston from said second longitudinal position to said first longitudinal position. In order to expand from and return to said production size, it may be necessary to have an enclosed space in order to cope with the change of volume of the piston, in relation to the inner pressure of said piston. The small size of a construction and the complexity of the members making the variability possible makes it unlikely to have a reliable, long lasting and economical enclosed space, having a variable volume.

This invention was initiated with solutions for the problem of optimizing ergonomically the reading of a parameter such as pressure or temperature of a tyre by manual operation of a piston chamber combination, e.g. a floor pump. Current pressure gauges are positioned so far away from the user, that she or he needs to have a telescope or binoculars to enable a normal reading. As no user will use such view enhancers, many pressure gauges are being equipped with a manually rotatable pointer of a color, different from the pointer of the pressure gauge. The first mentioned pointer is pointing at the desired end pressure, and is set before the pumping session. Thereafter it is easier to assess on a distance of the difference in position of both pointers. The problem is, that end pressures of tyres normally differ from each other, and that the pointer needs to be set, mostly every time before starting the pumping. This is uncomfortable

The reason for all this, is that the pressure of a tyre in most current pumps is measured pneumatically in the hose of the pump. This prohibits the transmittal of the pneumatic information from the hose of the pump to another part of the piston-chamber combination, normally the chamber, closest to the user of the pump, due to the fact that there is a check valve between the pump and its hose, at least in high pressure pumps

A common used solution is using a wireless (=by means of electromagnetic waves) transmission for this transmittal. It normally however means the use of electronic parts, and specifically batteries or another electric source. This is expensive, resources demanding and change of batteries is uneasy to handle by a common user.

### OBJECT OF THE INVENTION

The object is to provide solutions for a simple, reliable, long lasting and economical enclosed space, and for measuring a parameter.

### SUMMARY OF THE INVENTION

This invention may optionally be used for a container type piston, which has an approximately constant size of the circumference of its transversal cross-section.

The piston may preferably be inflatable.

The wall of the piston may preferably comprise reinforcement means.

In a cross-section through the longitudinal direction, the container, when being positioned at the first longitudinal position of the chamber, may optionally have a first shape which is different from a second shape of the container when being positioned at the second longitudinal position of said chamber. At least part of the deformable material may be compressible and wherein the first shape may have an area being larger than an area of the second shape. The deformable material may at be least substantially incompressible.

The piston may comprising an elastically deformable container, the container comprising an elastically deformable wall, and inside said wall a deformable material, said material may be different from and/or having different characteristics than that of the material of said wall.

The deformable material inside said wall may be a fluid, or a mixture of fluids, or a foam.

A container type piston wherein the piston may preferably produced to have a production-size of the container in the stress-free and undeformed state thereof in which the circumferential length of the piston is approximately equivalent to the circumferential length of said chamber at said second longitudinal position, the container optionally being expandable from its production size in a direction transversally with respect to the longitudinal direction of the chamber thereby providing for an expansion of the piston from the production size thereof during the relative movements of the piston from said second longitudinal position to said first longitudinal position.

In order to expand from and return to said production size of an e.g. inflatable piston, it may be necessary to have an enclosed space in order to cope with the change of volume of the piston, in relation to the inner pressure of said piston. The enclosed space is functioning as the extra volume of the container.

In the first aspect, the invention relates to a piston chamber combination, wherein the volume of the enclosed space is at least substantially constant.

The starting point of the design of a device such as e.g. a pump may be the enclosed space having an unvariable volume. Still the piston may have a variable volume, and is than using the enclosed space as extra volume, e.g. in order to comply to demands toward maintaining a certain internal pressure while moving in the elongate chamber, which may be necessary to e.g. maintaining sealability to the wall of the chamber.

The ultimate solution is just avoiding additional members, which are controlling the variability of the volume of the enclosed space. The enclosed space may be a closed chamber, communicating with the piston, thus having an open end to inside of the piston and for the rest closed, so that the volume of said enclosed space remains constant. Optionally may said volume be adjustable. Specifically for piston-chamber combinations, such as e.g. innovative tyre inflation pumps, where the cross sectional area's of the chamber are differing during the stroke is the size of the operating force of these pumps not anymore representing the size of the pressure in the tyre, and it is necessary to have a reliable and non-expensive pressure reading of the tyre pressure in a gauge, nearby the user during the pump stroke, e.g. nearby the handle on top of the piston rod in case of a floorpump. The piston rod may be hollow and may be used as an enclosed space for the container type piston. Through the piston rod there may be a tube, ranging from the chamber under the piston to a gauge, e.g. positioned on top of the piston rod. Said tube comprising the enclosed measuring space within said tube, in which a parameter in the chamber, e.g. the pressure may be measured.

The gauge may be a pneumatic gauge (manometer), òr it may be an electric/electronic gauge. A wireloom through the enclosed space of enclosed measuring space may be avoided, when the sensor is positioned near the top of the enclosed measuring space, e.g. in the gauge housing.

In the second aspect, the invention relates to a piston chamber combination, wherein the piston is inflatable, and wherein the inlet of the enclosed space is comprising a check valve.

In order to inject the deformable material (a fluid or a mixture of fluids and/or foam) inside the wall of the piston, and, if necessary further pressurizing said piston, the enclosed space may have an inlet. Leakages in the inlet must be avoided, for keeping the volume of the enclosed space constant. This may be done with a check valve. Incidental deflation for e.g. maintenance purposes of the piston may be done manually, by pressing the ball of the check valve to a position inside said check valve.

In the third aspect, the invention relates to a piston chamber combination, comprising a sensor positioned at the bottom of the piston rod, and a gauge on top of the piston rod, connected through a wireloom through the enclosed space, said wire loom is embedded in a material, which is sealing the inlet and outlet, and which is comprising a stepped transition in the enclosed space at the outlet.

Said wire loom inlet and outlet should be sealing 100%, in order to keep the volume of the enclosed space unchanged. This may be done by embedding said wire loom in a material, which is sealing the rest hole around the wireloom at the inlet and the outlet spot. In order to avoid that the wireloom and seal are being pressed out by the fluid or foam in the enclosed space, the enclosed space has a stepped transition, wherein the smallest diameter is nearest the top of the piston rod, in which said seal is fitting.

In a fourth aspect, the invention relates to a piston chamber combination, wherein the combination is comprising an enclosed measuring space with an inlet at the bottom of the piston rod, and a gauge on top of the piston rod, connected by a channel in a tube through the enclosed space, wherein an O-ring is sealing said tube at least at the top of the piston rod.

In a fifth aspect, the invention relates to a combination which additionally is comprising a measurement system comprising a gauge, and an enclosed measuring space in which a parameter is being measured, wherein said enclosed space may be closed by a sealing between the gauge housing and said gauge.

Other solutions to close the chamber further from the piston are possible, but not shown.

And, a combination wherein the gauge may comprising the sensor, and where the sensor is communicating with the enclosed measuring space.

In the first aspect, the invention relates to a sensor-reader combination, wherein

the measuring is done in a measuring space, representing said device regarding to the to be measured size of said parameter, said space is positioned nearby said reader.

Obvious solutions for the transmittal of the information of a value of a parameter between parts of the combination moving relatively to each other is e.g. by an elastic wire of which each end may be connected to each part. In a pump with high pressures, will the life time of such wire being negatively affected by the harsh climate of the inside of the pump, and if not, the solution would be expensive.

Another obvious solution would be to use contacts which glide over each other during the stroke, where e.g. a contact rail would be connected to one of the moving parts, while a contact (flexible strip, or a springforce operated contact) would slide on said rail, and be connected to the other part. Not a very reliable solution in a harsh climate inside a pump. And, used in a floor pump, this would possibly prohibit the handle to rotate enough for being comfortable to pump with. This solution would be expensive as well, and not very reliable.

An obvious wireless solution is to measure e.g. the pressure in the hose of a pump, and transmit the information wireless to a receiver on the piston rod, and have a reading on a gauge on top of a handle which is operated by the user. Even this solution seems to be reliable, this solution is expensive, only already by having an electrical source on two different places.

Better solutions must be provided.

In this invention is the fact that the space of the tyre to be inflated is in direct contact with the space in the pump under the piston, during overpressure or just before balance of pressure of the pump in relation to the pressure in the tyre. That means that the size of the pressure/temperature in the tyre may be readable by measuring said parameter in the space under the piston of the pump, and in case of a high pressure pump, before the check valve, which is normally positioned between said space under the piston and the hose, which connects the pump to the valve connector, which is mounted on the tyre valve. Said space is called the measuring space. The measuring space is surrounding the bottom part of the piston rod, and thereby it may be possible to communicate by a channel (pneumaticly) or by wires (electrically) between the sensor (a pressurized spring in a manometer, òr a transducer mounted on said piston rod end òr mounted on a printboard and connected by a channel to the measuring space) through said piston rod to the reader on top of the piston rod (manometer òr an electric volt/current meter òr an electronic display, respectively). Said channel is ending at said piston rod end.

In the second aspect, the invention relates to a sensor-reader combination wherein said measuring space is communicating during a part of the operation with said device.

In case of current pumps for tyre inflation, measuring of the pressure of the tyre is done in the hose of the pump. This hose is at one end connected to the chamber through a non-return valve, and at the other end connected to a valve connector. The non-return valve limits the size of the dead space of the pump. In current low pressure pumps is no non-return valve present, but no pressure gauge is normally used.

The pressure in the hose may than be representative for the pressure in the tyre, because the tyre valve closes when there is pressure equivalency between the space in the hose, and the space of the tyre. This happens in current pumps, when the piston has reached its end point after a pump stroke, and is starting to return, thus when the overpressure in the chamber drops. The reason is, that the non-return valve between the cylinder and the hose is closing as well at this point of time.

The pressure in the space of the chamber between the piston and said non-return valve may than also be representative for the tyre pressure as well, when the piston is about to return for a new stroke. This opens a solution where the pressure may be measured at the end of the piston (rod) which is adjacent the space between the piston and a non-return valve. Thus may a sensor (measuring means) and a reading means be placed on one of the parts, e.g. on the piston (rod) in a pump for tyre inflation. The sensor may be positioned on the piston rod, and best at the end of the piston rod, in order to enable a surface for the guiding means of the piston rod. It may then be possible to have a reading on a gauge which is positioned on top of the handle of the piston rod—thus closest to the user, and readable during operation.

E.g. in case of pressure reading: this reading may be done by a pneumatic pressure gauge, where the gauge is connected by e.g. a channel within a tube to the measuring space between the piston and the valve connector òr the non-return valve. The same is valid if a temperature is being measured with a e.g. bimetal sensor. The small size of the tube and its length may give rise to dynamic friction, and may contribute to dampen the fluctuations of the pressure due to the strokes the piston is performing.

The measuring by the sensor may also be done by an electric pressure transducer, which gives through an amplifier a signal to a digital pressure gauge òr an analog pressure gauge (a volt meter or a current meter). The same is valid if a temperature is being electrically monitored.

In order to make the sensor-reader combination still more profitable, the sensor may be assembled on the printboard, while the sensor is connected to the measuring space through a channel.

In the third aspect, the invention relates to a sensor-reader combination, wherein:

the size of the parameter is measured in an enclosed measuring space.

Direct measuring in the measuring space may give fluctuations of the size of the parameter, as e.g. in a piston floor pump for tyre inflation with regard to the pressure, but also with regard to the temperature. In order to simulate the pressure in the tyre within the pump, a conditioned measuring space is necessary, and this may be done by an enclosed space.

If the value of the parameter is measured in an enclosed measuring space, it is necessary to get the fluid in, measure it and read it. Thereafter get it out again for the next measurement. E.g. in case a pressure in a tyre is measured in a floor pump, a part of the measuring space may be entered into the enclosed measuring space for enabling the measurement. This may be done by a check valve òr an electrically controlled valve. For getting the contents of the enclosed measuring space out again after the measurement, a new valve (check valve or an electrically controlled valve)—it may also be a channel, which is so tiny that dynamic friction may delay the flow out of the enclosed measuring space so much that this flow does not influence so much the measurement. This delay may be also used for the following purpose. E.g. in case of a pressure measuring in a piston-chamber combination, it may be necessary to maintain the value of the tyre pressure when the piston is returning after a pump stroke, until the value of this parameter in the space adjacent the space between the piston and a non-return valve or valve connector has reached its maximum value of the pump stroke before, by the next pump stroke. That temporary maintaining of this value may be done electronically (e.g. by the use of a condensator), by software controlling an IC, by mechatronics—the position of the piston rod in relation to the pump, controlling an IC, òr just by mechanics alone: e.g. an enclosed measuring space, which may be connected by a valve to the measuring space (between the piston and the valve connector, òr the space between the piston and the non-return valve between the combination and the hose in case of a pump for tyre inflation). The valve may preferably be identical with the valve between the combination and the hose, so that opening and closing happen simultaneously.

The enclosed measuring space may comprise a channel which is open in a very controlled way, so that the maximum value of the pressure may be temporarily maintained during the return of a piston during a pump stroke, simulating the pressure in the tyre. It may be a tiny channel, which connects the enclosed measuring space with the measuring space. During pumping may a very small part of the volume of the enclosed measuring space flow to the measuring space, and may influence the reading a bit, but only during the return path of the pump stroke, which is not very relevant for the reading. The flow through said tiny channel may be controlled by the dynamic friction of said channel, depending on its length, diameter and surface roughness, but also by a screw which has a tiny hole as well, e.g. in the case where the thread has been locked by a locking fluid .

When the requested pressure has been reached, will the movement of the piston stop, and will the pressure in the enclosed measuring space become equal with the pressure in the measuring space, which is the pressure of the tyre. Firstly when the hose has been disconnected from the tyre valve, the pressure in the measuring space decreases to atmospheric pressure (even there is a check valve in between), and will the pressure in the enclosed measuring space decrease to atmospheric pressure. It is necessary than to have a valve connector which is open, if no overpressure comes from the pressure source.

In order to allow the preservation of the pressure (or temperature), the measuring space comprises an outlet valve which may be initiated electrically, and which is closing the measuring space when the pumping is being initiated, and is opening after a certain short period when pumping has been done. This is only an example of a controlling arrangement. It may also be done manually, e.g. by pressing a button for closing the measuring space before the pump session, and opening up again, thereafter, by pressing said button again.

The best simulation may of course be done by a computer program, which is controlling the inlet and outlet valves, while the last mentioned are valves which may be controlled electrically/electronically. This may be done in much bigger and more costly installations, which may need maintenance, than that of a floor pump for inflation purposes.

In case of e.g. a container (envelope) piston type (claim 5) according to EP 1179140, which uses an enclosed space, the enclosed space may be preferably positioned behind the measuring space, relative to the space adjacent the space between the piston and a non-return valve, if an electric gauge is used.

In case of a pneumatic gauge (=manometer), the enclosed space may be positioned independently of the measuring space. This may be done by a separate (measuring) channel from the measuring space to the pneumatic pressure gauge.

A piston-chamber combination comprising an elongate chamber which is bounded by an inner chamber wall and comprising a piston means in said chamber to be sealingly movable relative to said chamber at least between first and second longitudinal positions of said chamber, said chamber having cross-sections of different cross-sectional areas at the first and second longitudinal positions of said chamber and at least substantially continuously differing cross-sectional areas at intermediate longitudinal positions between the first and second longitudinal positions thereof, the cross-sectional area at the first longitudinal position being larger than the cross-sectional area at the second longitudinal position,

said piston means being designed to adapt itself and said sealing means to said different cross-sectional areas of said chamber during the relative movements of said piston means from the first longitudinal position through said intermediate longitudinal positions to the second longitudinal position of said chamber, wherein the piston comprises an elastically deformable container comprising a deformable material. Said piston means may be comprising an enclosed space communicating with the deformable container (envelope), the enclosed space may have a constant volume. The container(or envelope) may be inflatable. This may be necessary when having a measuring channel or a wire loom inside the enclosed space, if the enclosed space is relatively small, like the situation is in a floor pump for tyre inflation. The circumferential size of this piston type is that of the chamber.

A piston-chamber combination comprising an elongate chamber which is bounded by an inner chamber wall and comprising a piston in said chamber to be sealingly movable relative to said chamber wall at least between a first longitudinal position and a second longitudinal position of the chamber, said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position, said piston comprising a container which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber, wherein the piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the piston from said second longitudinal position to said first longitudinal position. Said piston means may be comprising an enclosed space communicating with the deformable container (envelope), the enclosed space may have a constant volume.

The circumferential size of this piston type may be that of the chamber on its smallest circumferential size.

In case of e.g. a piston type according to claim 1 according to EP 1179140 is used, neither an enclosed space 42 (FIGS. 3A-C) may be necessary, nor the inflation nipple 43 (FIGS. 3A-C). The enclosed space may be used then as channel 52 (FIGS. 3A-C) òr as inlet channel for the measuring space. The check valve 43 maybe put in a reversed position.

The sensor-reader combination may be used in any device where a the sensor is remotely positioned in relation to the reading means, such as pumps, actuators, shock absorbers or motors.

The above combinations are preferably applicable to the applications.

Thus, the invention also relates to a pump for pumping a fluid, the pump comprising:

a combination according to any of the above aspects,

means for engaging the piston from a position outside the chamber,

a fluid entrance connected to the chamber and comprising a valve means, and

a fluid exit connected to the chamber.

A pump where the engaging means have an outer position where the piston means is at the first longitudinal position of the chamber, and an inner position where the piston means is at the second longitudinal position of the chamber.

A pump where the engaging means have an outer position where the piston means is at the second longitudinal position of the chamber, and an inner position where the piston means is at the first longitudinal position of the chamber.

The invention also relates to an actuator comprising:

a combination according to any of the combination aspects, means for engaging the piston from a position outside the chamber,

means for introducing fluid into the chamber in order to displace the piston between the first and the second longitudinal positions.

The actuator may comprise a fluid entrance connected to the chamber and comprising a valve means.

Also, a fluid exit connected to the chamber and comprising a valve means may be provided.

Additionally, the actuator may comprise means for biasing the piston toward the first or second longitudinal position.

And, an actuator where the introducing means may comprise means for introducing pressurised fluid into the chamber.

An actuator where the introducing means may be adapted to introduce a combustible fluid, such as gasoline or diesel, into the chamber, and wherein the actuator further comprises means for combusting the combustible fluid.

An actuator where the introducing means may be adapted to introduce an expandable fluid to the chamber, and wherein the actuator further comprises means for expand the expandable fluid.

An actuator further comprising a crank adapted to translate the translation of the piston means into a rotation of the crank.

Finally, the invention relates also to a shock absorber comprising:

a combination according to any of the combination aspects,

means for engaging the piston from a position outside the chamber, wherein the engaging means have an outer position where the piston is in its first longitudinal position, and an inner position where the piston is in its second longitudinal position.

The absorber may further comprise a fluid entrance connected to the chamber and comprising a valve means.

Also, the absorber may comprise a fluid exit connected to the chamber and comprising a valve means.

A shock absorber wherein the chamber and the piston means form an at least substantially sealed cavity comprising a fluid, the fluid being compressed when the piston means moves from the first to the second longitudinal positions of the chamber.

A shock absorber may further comprising means for biasing the piston means toward the first longitudinal position of the chamber.

Piston chamber combination comprising a piston in a chamber with a fluid exit and a sensor-reader combination with a sensor for measuring a parameter wherein the sensor is arranged to measure the parameter in a measuring space before the fluid exit of the chamber.

Piston chamber combination where the fluid exit is provided with a check valve.

Piston chamber combination where the sensor is located in an enclosed measuring space in the piston.

Piston chamber combination comprising a check valve between the enclosed measuring space and the chamber.

Piston chamber combination where the piston comprises a hollow piston rod enclosing the enclosed measuring space.

Piston chamber wherein a channel with a very small diameter connects the enclosed measurement space to the chamber.

Piston-chamber combination comprising a screw for adjusting flow through the channel.

Piston-chamber combination where the screw has a tapered head matching a correspondingly widened end of the channel and wherein a channel runs through the head from the tapered side to an opposite side of the head.

Piston-chamber combination wherein the enclosed measuring space comprises an inlet and an outlet valve initiated electrically under the control of a computer.

Piston-chamber combination wherein the sensor-reader combination comprises pressure sensor, selected from the group of pneumatic or electric pressure gauges, analogue or digital volt or current meters in combination with an electric or electronic sensor, and transducers connected with mechanical conducting devices, such as wires, to an analogue or digital gauge.

Piston-chamber combination wherein the sensor-reader combination comprises a temperature sensor.

Piston-chamber combination wherein the piston-chamber combination is a pump comprising means for engaging the piston from a position outside the chamber and a fluid entrance connected to the chamber, the fluid entrance comprising a valve.

Piston chamber wherein the piston comprises a piston rod with a handle on top of the piston rod, wherein the handle is provided with an electric or pneumatic pressure gauge.

Method of measuring pressure in a tyre during pumping by using a pump with a piston in a chamber and with a fluid exit connected to a hose and a check valve between the fluid exit and the hose wherein the tyre pressure is measured indirectly by measuring the pressure in the chamber before the check valve, at least during a pump stroke when the piston is pushed into the chamber.

Method wherein the pressure is measured in an enclosed measuring space in the piston and wherein the enclosed measuring space is connected to the chamber with an opening provided with a check valve which provides an open connection between the enclosed measuring space and the chamber when the piston is moved into the chamber during a pump stroke and which closes off said opening of the enclosed measuring space during a return stroke.

A sensor-reader combination for measuring the size of a parameter of a device, the device and reader are positioned at a different physical position from each other, the measuring is done in a measuring space representing said device regarding to the to be measured size of said parameter, said space is positioned nearby said reader.

The measuring space is communicating during a part of the operation with said device.

The sensor and said reader are part of the same assembly.

The reading is done by a pneumatic pressure gauge, which is connected to said space.

The reading of a parameter is done by an analog volt meter or current meter, in combination with an electric or electronic sensor.

The reading of a parameter is done by a digital volt meter or current meter, in combination with an electric or electronic sensor.

Said sensor is connected to the measuring space through a channel.

The parameter is measured inside an enclosed measuring space.

The enclosed measuring space is comprising a check inlet valve, connecting said enclosed measuring space with said measuring space.

Said check inlet valve of the enclosed measuring space is identical with the outlet check valve of the measuring space.

The enclosed measuring space may comprising a check outlet valve, connecting said enclosed measuring space with said measuring space.

Said enclosed measuring space may comprising a channel connecting said enclosed measuring space with said measuring space.

The channel may have a very small diameter.

The channel may comprising a screw.

The screw may comprising a small channel.

The channel may have a widened end towards said screw.

The screw may have a tapered end towards said channel.

The measuring may be done by a transducer communicating with the measuring space, which is connected with mechanical conducting devices, such as wires, to an analog electrical and/or digital gauge.

The measuring may be done by connecting the measuring space with the inlet of the pneumatic gauge (manometer) by a measuring channel.

The measuring may be done by connecting the transducer to the enclosed measuring space, the transducer is connected with mechanical conducting devices, such as wires, to an analog electrical and/or digital gauge.

The enclosed measuring space may comprise an inlet and an outlet valve which are initiated electrically, and which are opening and closing the measuring space, and are controlled by a computer.

### BRIEF DESCRIPTION OF THE DRAWINGS

In the following, preferred embodiments of the invention will be described with reference to the drawings wherein:

FIG. 0 shows left the combination of a pneumatic pressure/temperature gauge and a channel within the piston rod, where the measuring point is at the end of the channel, communicating with in the measuring space—the lower part of the drawing has been scaled up 2:1. A scaled up detail is also shown. shows right the combination of a pneumatic pressure/temperature gauge and a wire loom within the piston rod, where the measuring point is at the transducer at the end of the piston rod, the transducer communicating with the measuring space—the lower part of the drawing has been scaled up 2:1. A scaled up detail is also shown.

FIG. 1A shows the top of the piston rod of a floor pump with an inflatable piston, with an electrical gauge mounted on top of the handle, and the bottom of the piston rod with the transducer in the enclosed measuring space.

FIG. 1B shows the bottom part of FIG. 1A on a scale 2:1.

FIG. 2A shows the top of the piston rod of a floor pump with an inflatable piston and a pneumatic gauge mounted on top of the handle, an in-between channel which ends in the enclosed measuring space.

FIG. 2B shows the bottom part of FIG. 2A on a scale 2:1

FIG. 3A shows the top of the piston rod of a floor pump with an inflatable piston and a pneumatic gauge mounted on top of the handle, and the bottom of the piston rod mounted in an enclosed measuring space.

FIG. 3B shows the bottom part of FIG. 3A on a scale 2.5:1.

FIG. 3C shows the outlet channel of the enclosed measuring space of FIG. 3B on a scale 6:1

FIG. 3D shows a detail of the outlet channel of FIG. 3C on a scale of 5:1

FIG. 4 shows the bottom of an advanced floor pump for e.g. tyre inflation.

FIG. 5A shows a section of a gauge housing, mounted on a handle, where the enclosed space is closed by an O-ring.

FIG. 5B shows a detail of the O-ring assembly.

FIG. 6A shows a section of a gauge housing, mounted on the handle, where the enclosed space is closed by a sealing near the gauge.

FIG. 6B shows a detail of FIG. 6A

### DESCRIPTION OF PREFERRED EMBODIMENTS

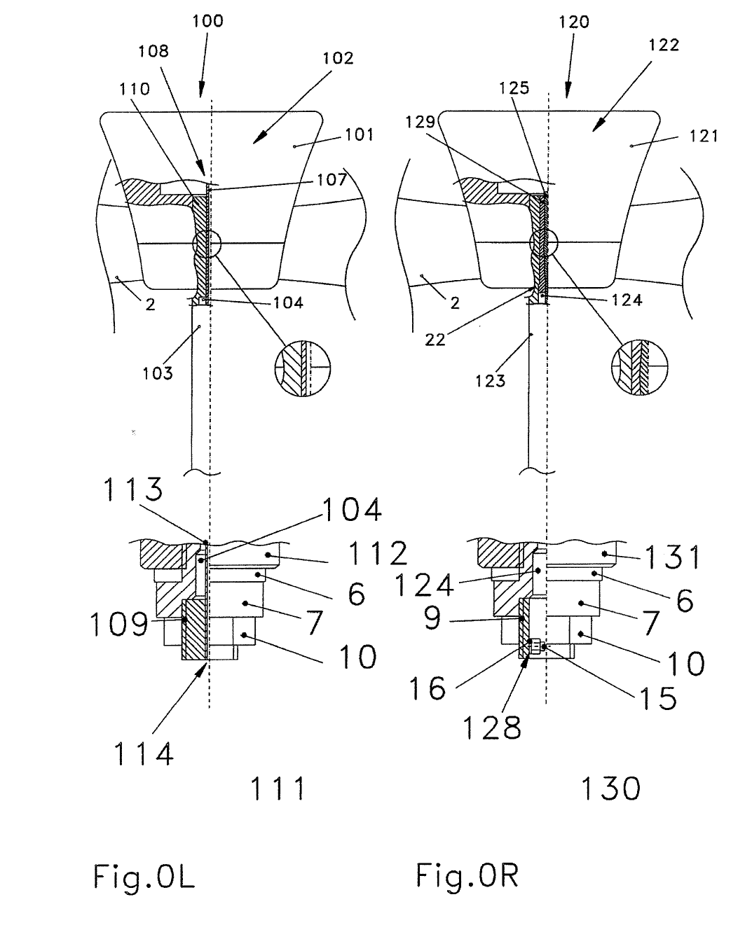

FIG. 0 shows left a reading point 100 of the measured value of a pneumatic pressure gauge housing 101. Within said gauge is a mechanical manometer 102 (not shown). Said gauge housing 101 is mounted on top of a piston rod 103. The piston rod 103 is hollow with channel 104, which is mounting a tube with a measuring channel 107 within tube 113, which makes communication possible between the pneumatic pressure gauge 102 and the entrance 108 of channel 108 at the bottom of the tube 107. The measuring point 108 in the housing 101, at the manometer entrance. The measuring room 111. The handle 2. The suspension 109. The spring washer 6. The bolt 7. The suspension 110 of the channel 107 in the top of the piston rod 103. The suspension 112 of the piston. The tube 113.

FIG. 0 right shows a reading point 120 of the measured value of an electric pressure/temperature gauge housing 121. Said housing 121 comprises an analog/digital electric gauge 122 (not shown). Said gauge 122 is mounted on top of a piston rod 123. The piston rod 123 is hollow with channel 124, in which a wire loom 125 is mounted. Said wire loom 125 is connected with a transducer 15, which is mounted on a platform 16, which makes communication possible between said gauge 121 and the measuring point 128 at the bottom of the piston rod 123. The measuring space 130. The handle 2. The spring washer 6. The bolt 7. The suspension 129 of the channel 124 in the top of the piston rod 123. The transition 22. The suspension 131 of the piston.

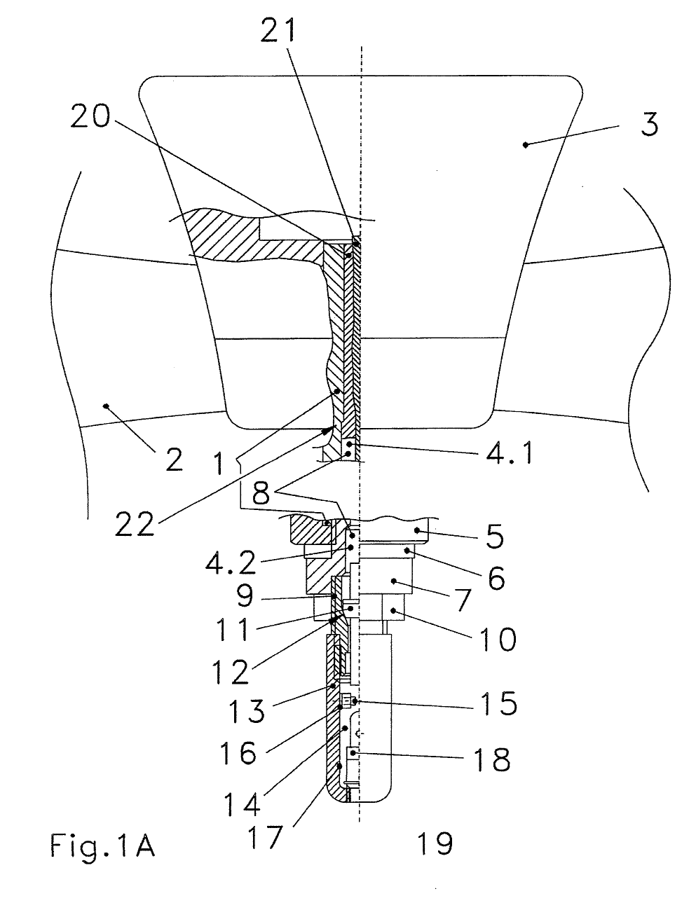

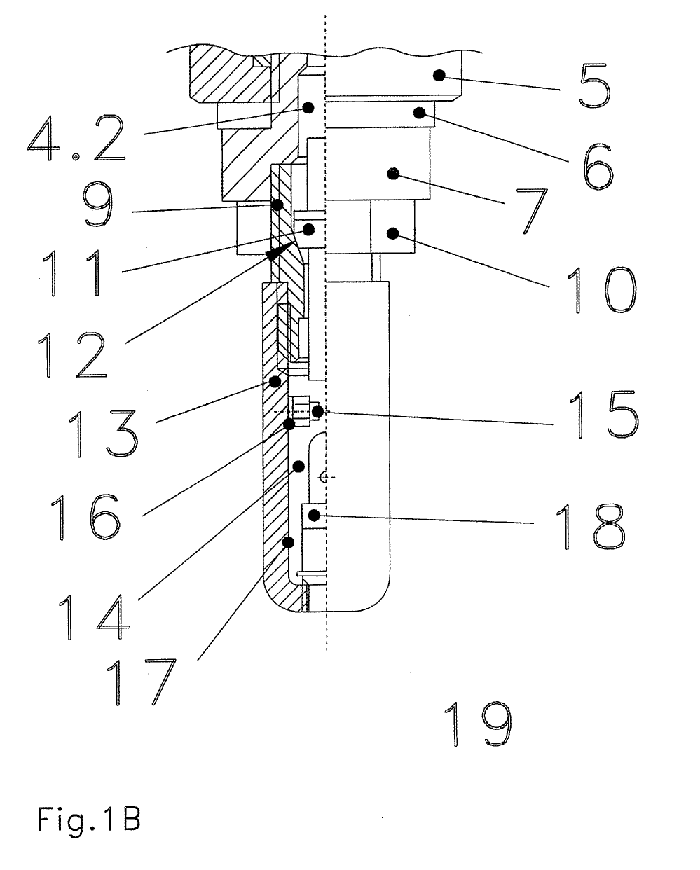

FIG. 1A shows the top of a piston rod 1 with a handle 2 and an electric (pressure/temperature) gauge 3. The gauge 3 is mounted on the handle 2. The piston rod 1 has a upper space 4.1 which is serving as an enclosed space 8 for the inflatable piston, of which only the bottom part of its suspension 5 is shown. The spring washer 6. The top of a bolt 7 is shown with the bottom space 4.2 of the enclosed space 8, which is directly connected to the upper space 4.1. In the top of bolt 10 is a valve body 9 mounted, and fastened by a nut 10. The core pin 11 is shown in a closed position against the stem 12 in the valve body 9. This valve 11 is serving to keep the enclosed space 8 on the necessary pressure. On the valve body 9 is the housing 13 of the enclosed measuring space 14 mounted. The (pressure) transducer 15 is shown, mounted on a platform 16. This platform 16 allows a gentle activation of the transducer 15, as the opening is between the wall 17 of the enclosed measuring space 14 and the transducer 15. The valve 18 which connects the measuring space 14 with the measuring space 19 adjacent the outlet of the combination. The top of the hollow piston rod 1 is closed by a filler 20, which is tightly closing the necessary wire loom 21 from the pressure transducer 15 to the gauge 3. The rest of the wiring is not shown. The transition 22 prohibits the filler 20 to be burst out of the piston rod. The outlet valve of the enclosed measuring space 14 is not shown.

FIG. 1B shows the bottom part of FIG. 1A on a scale 2:1.

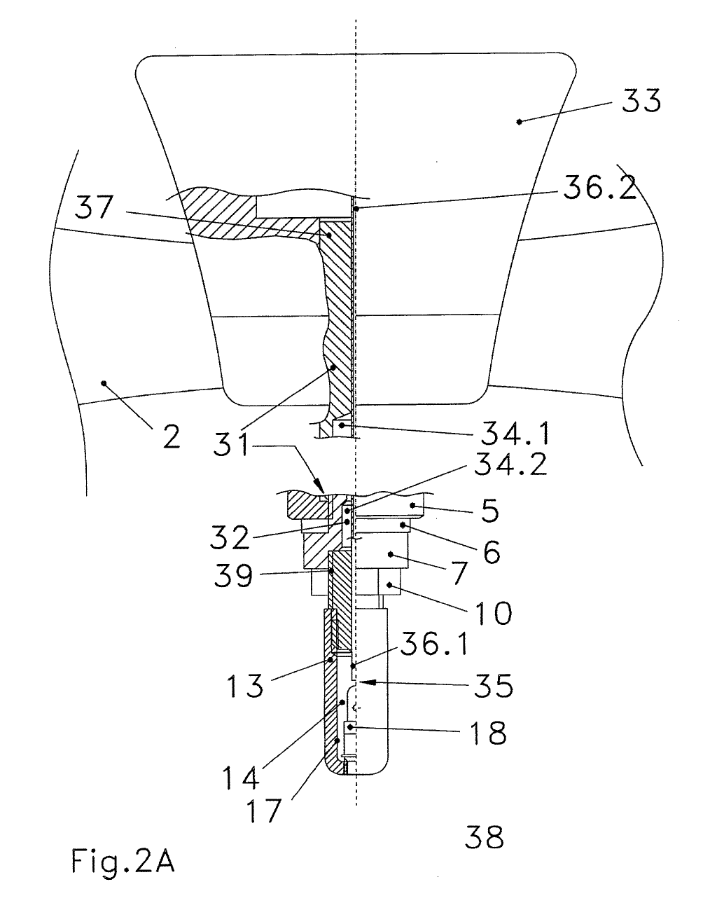

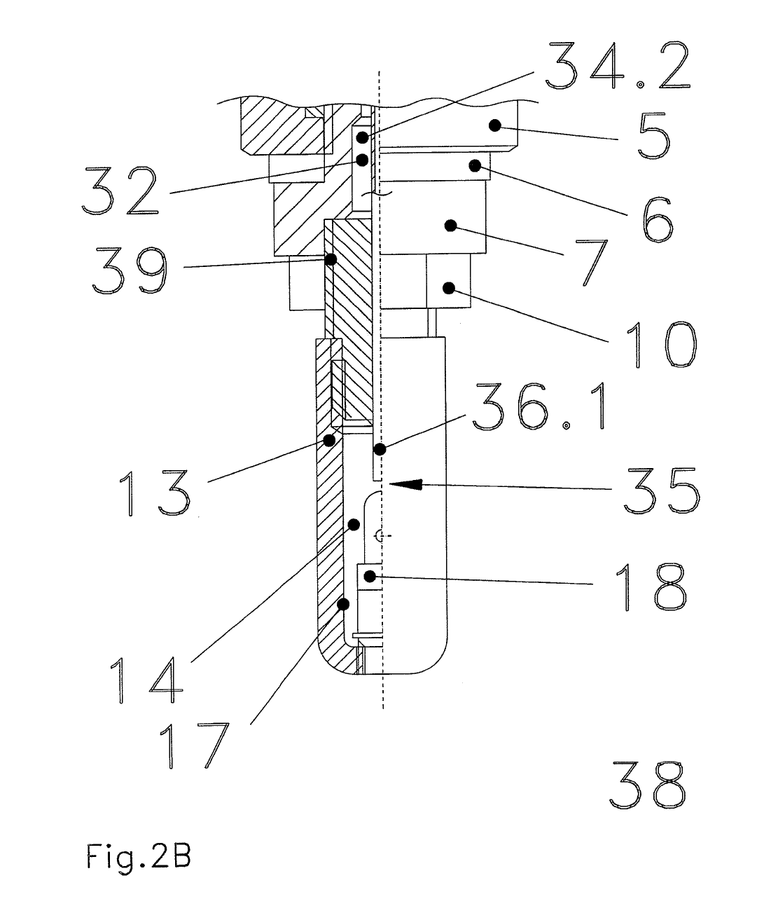

FIG. 2A shows the top of a piston rod 31 with a handle 2 and a pneumatic pressure gauge 33. Said gauge 33 is mounted on the handle 2. The piston rod 31 has a space 34.1 which is serving as an upper part of the enclosed space 32 for an inflatable piston, of which only the bottom part of its suspension 5 is shown. The spring washer 6. The top of a bold 7 is shown with part 34.2 which is serving as the lower part of the enclosed space 32, which is directly connected to the space 34.1. In the top of bolt 7 is a body 39 mounted, and fastened by a nut 10. On the body 39 is the housing 13 of the enclosed measuring space 14 mounted. The end 35 of the measuring channel 36 within tube 36.2 is shown which is tightly mounted in the top 37 of the piston rod 31, and connected to the pneumatic pressure gauge. The valve 18 which connects the enclosed measuring space 14 with the measuring space 38 adjacent the outlet of the combination.

The outlet valve of the measuring space 32 is not shown.

FIG. 2B shows the bottom part of FIG. 2A on a scale 2:1

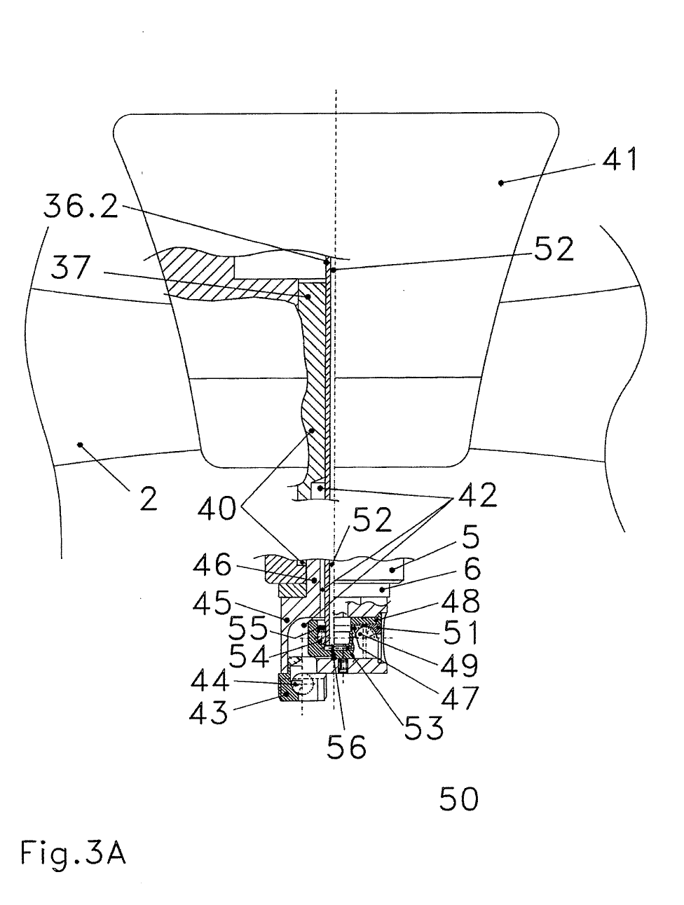

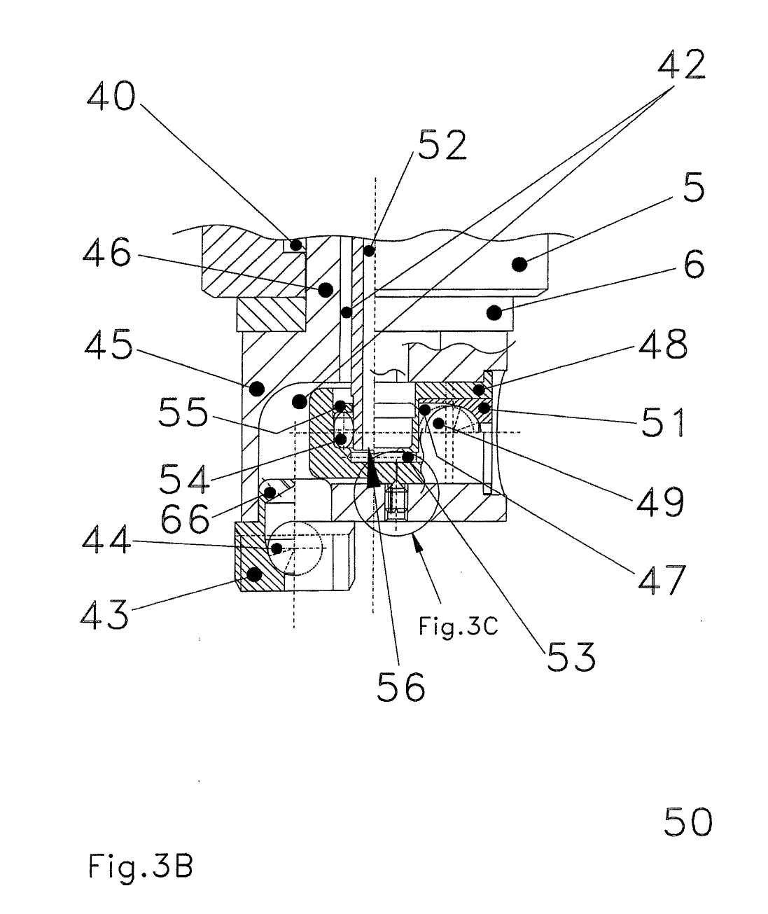

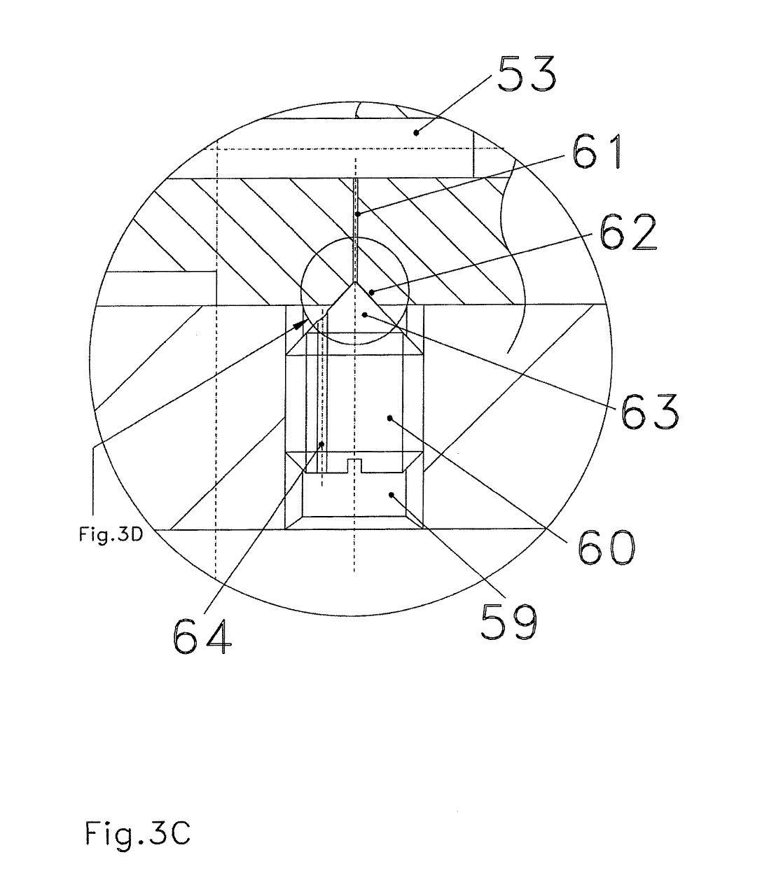

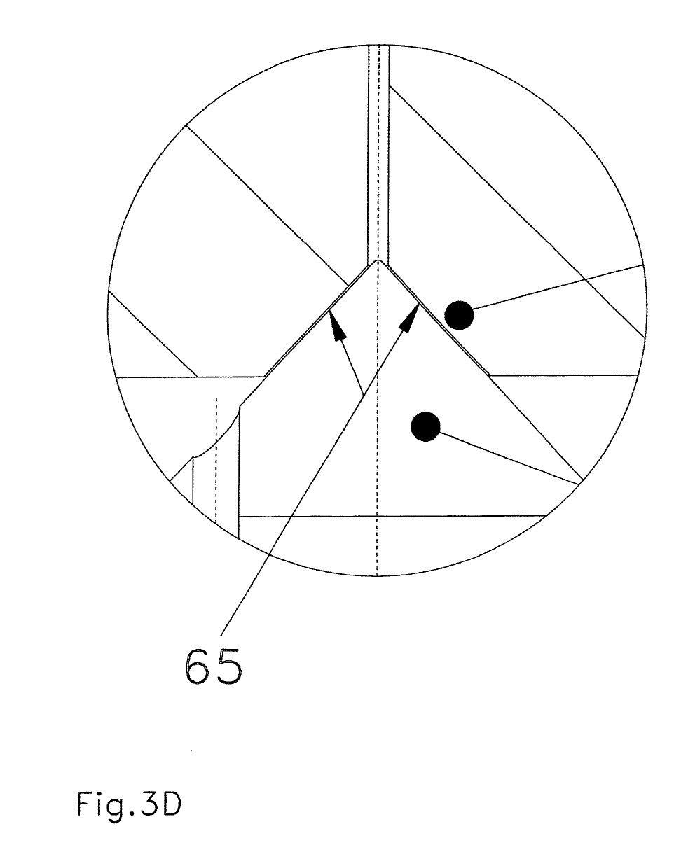

FIG. 3A shows the top of a piston rod 40 with a handle 2 and an electric pressure gauge 41. The gauge 41 is mounted on the handle 2. The piston rod 40 has an enclosed space 42 for keeping the piston pressurized. Said space can communicate with the piston (see e.g. WO2000/070227 or WO2002/077457 or WO2004031583). Pressurization to a desired level of the piston is done by an external pressure source (not shown) through an inflation nipple 43, which has an build in check valve 44. The exit hole 66 of the check valve 44. The nipple 43 is positioned at the bottom of the piston rod 40, and build in the head 45 of the bolt 46. The enclosed measuring space 47 is build in a separate housing 48 in the head 45 of bolt 46. Said enclosed measuring space is connected through a check valve 49 with the measuring space 50. Said check valve 49 is built in a separate housing 51. The (vertical) channel 52 is connected to the enclosed measuring space 47 within the tube 36.2 by means of a (horizontal) channel 53, and is sealed by a sealing means 54, e.g. an O-ring, in the enclosed measuring space 47. The cap 55, which is a part of the O-ring gland. Either is the transducer 15 mounted on the bottom 56 of the tube 57, where the channel 52 is filled in with a wire loom 57 to the electric pressure gauge 41, òr is the channel 52 open, and on top 58 of the channel 52, within the electric pressure gauge 41, is the transducer 15 mounted. FIG. 3B shows the bottom part of FIG. 3B on a scale 6:1.

FIG. 3C shows a part of the enclosed measuring space (47, 43, 52) on a scale of 6:1 in relation to FIG. 3B. The outlet channel 59 in the head 45 of the bolt 46, with an screw 60, which sets the flow through the tiny channel 61 in the housing 48 of the enclosed measuring space 47. The channel 61 has a widened end 62, which suits the tapered end 63 of the screw 57. In the screw 60 is a channel 64 that connects the channel 61 with the outlet channel 59.

FIG. 3D shows a detail of FIG. 3C on a scale 5:1. The very small space 65 between the widened end 62 and the tapered end 63. It sets the flow from the channel 53.

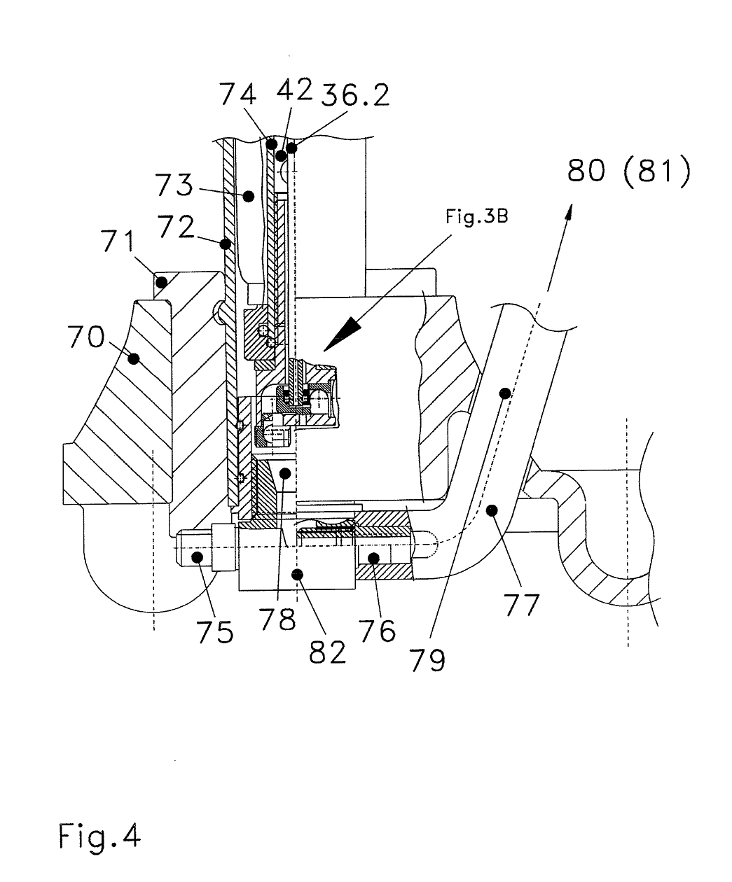

FIG. 4 shows the bottom part 70 of an advanced floor pump for e.g. tyre inflation. The flexible manchet 71 keeps the cone formed tube 72 in place. The inflatable piston 73. On the bottom of the piston rod 74 is the embodiment of FIGS. 3A-D mounted, without crew 57 arrangement (may only be necessary for prototypes). The enclosed space 42. The tube 36.2. The inlet check valve 75 The outlet check valve 76. The hose 77. The measuring space 78, 79 (inside the hose). The valve connector 80 (not shown). The space inside the valve connector 81 is also part of the measuring space (not shown). The central axis 82 of the pump.

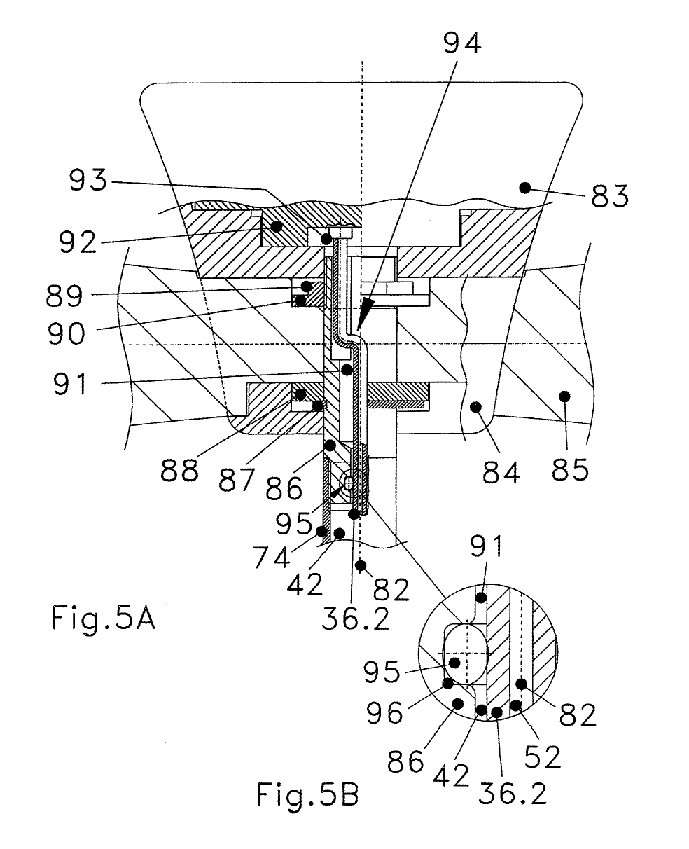

FIG. 5A shows an assembly of a gauge housing—top part 83 and bottom part 84, assembled with scrues (not shown)—on a handle 85 of a floor pump of FIG. 4. The piston rod 74, which is mounted on a nipple 86, on which the handle 85 has been mounted. This is done by a spring washer 87 and a spacer 88. A nut 89 which is comprising a washer 90 is keeping the handle 85 in place. The piston rod 74 is comprising the enclosed space 42, which is permanently separated from space 91 by an O-ring 95. The O-ring 95 is mounted in the nipple 86 and is tightening the tube 36.2, which is comprising the enclosed measuring space 52, and thereby has the enclosed space 42 a constant volume. In order to be able to mount the pneumatic pressure gauge 92 on the tube 36.2, the tube is comprising an S-bend 94, and has on its top a nipple 93—the nipple 93 is sealed (not shown) to the gauge housing. The pneumatic pressure gauge has been mounted in the top part 83 of the pneumatic pressure gauge housing by e.g. scrues (not shown). The centre axis 82.

FIG. 5B shows a detail of the assembly of the O-ring 95. The gland 96 wherein the O-ring 95 has been mounted, sealing the tube 36.2. The space 91. The enclosed measuring space 52. The centre axis 82.

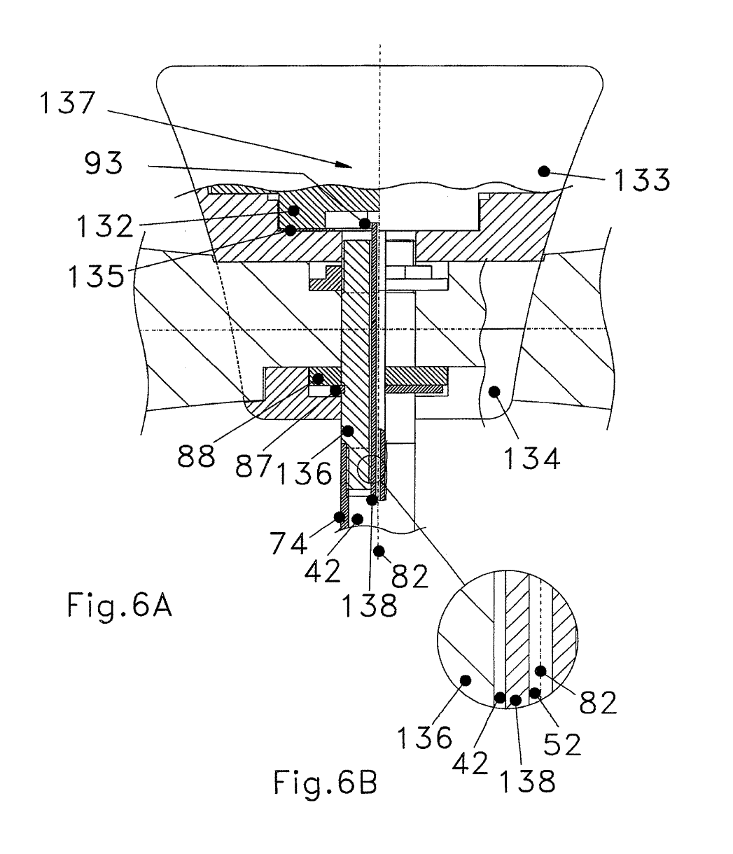

FIG. 6A shows an assembly of a gauge housing—top part 133 and bottom part 134, assembled with scrues (not shown)—on a handle 85 of a floor pump of FIG. 4. The piston rod 74, which is mounted on a nipple 136, on which the handle 85 has been mounted. This is done by a spring washer 87 and a spacer 88. A nut 89 which is comprising a washer 90 is keeping the handle 85 in place. The nipple 93—the nipple 93 is sealed (not shown) to the gauge housing. The piston rod 74 is comprising the enclosed space 42. The sealing 135 is mounted between the electric pressure gauge 132 and the top part 133 of the gauge housing, sealing the enclosed space 42 and thereby has the enclosed space 42 a constant volume. The electric/electronic pressure gauge has been mounted in the top part 83 of the gauge housing by e.g. scrues (not shown). The sensor 137 (not shown) at the top end of the enclosed measuring space 52, within the top part 133 of the gauge housing, which is communicating with the enclosed measuring space 52 (not shown). The tube 138 comprising the enclosed measuring space 52. The centre axis 82.

FIG. 6B shows a detail of the enclosed space 42 and the enclosed measuring space 52. The tube 138. The centre axis 82. The tube 138.

Piston Chamber Combination reference numbers

| | | |
|---|---|---|
| 1 | piston rod | FIG. 1A |
| 2 | handle | FIG. 1A/2A/0 |
| 3 | gauge | FIG. 1A |
| 4.1 | upper space (of the | FIG. 1A |
| | enclosed space 8) | |
| 4.2 | bottom space (of the | FIG. 1A |
| | enclosed space 8) | |
| 5 | suspension (of the | FIG. 1A/1B/2A/2B |
| | inflatable piston) | |
| 6 | spring washer | FIG. 1A/1B/2A/2B/0 |
| 7 | bolt | FIG. 1A/1B/2A/2B/0 |
| 8 | enclosed space (for | FIG. 1A/1B/2A |
| | the inflatable piston) | |
| 9 | valve body | FIG. 1A/1B |
| 10 | nut | FIG. 1A/1B/2A/2B |
| 11 | core pin | FIG. 1A/1B |
| 12 | stem | FIG. 1A/1B |
| 13 | housing | FIG. 1A/1B/2A/2B |
| 14 | enclosed measuring | FIG. 1A/1B/2A/2B |
| | space | |
| 15 | transducer | FIG. 1A/1B/0R |
| 16 | platform | FIG. 1A/1B/0R |
| 17 | wall (of the | FIG. 1A/1B/2A/2B |
| | measuring space) | |
| 18 | valve | FIG. 1A/1B/2A/2B |
| 19 | measuring space | FIG. 1A |
| 20 | filler | FIG. 1A |
| 21 | wiring loom | FIG. 1A |
| 22 | transition | FIG. 1A/0R |
| 31 | piston rod | FIG. 2A |
| 33 | gauge | FIG. 2A |
| 34.1 | space (upper part of the | FIG. 2A |
| | enclosed space 32) | |
| 34.2 | space (lower part of the | FIG. 2A/2B |
| | enclosed space 32) | |
| 35 | end | FIG. 2A/2B |
| 36.1 | measuring channel | FIG. 2A/2B |
| 36.2 | tube | FIG. 2A/3B/4/5A/5B |
| 37 | top | FIG. 2A |
| 38 | measuring space | FIG. 2A |
| 40 | piston rod | FIG. 3A/3B |
| 41 | electric pressure gauge | FIG. 3A/3B |
| 42 | enclosed space | FIG. 3A/3B/4/5A/5B/6A/6B |
| 43 | inflation nipple | FIG. 3A/3B |
| 44 | check valve | FIG. 3A/3B |
| 45 | head | FIG. 3A/3B |
| 46 | bolt | FIG. 3A/3B |
| 47 | enclosed measuring space | FIG. 3A/3B |
| 48 | housing | FIG. 3A/3B |
| 49 | check valve | FIG. 3A/3B |
| 50 | measuring space | FIG. 3A/3B |
| 51 | housing | FIG. 3A/3B |
| 52 | channel | FIG. 3A/3B/5B/6B |
| 53 | channel | FIG. 3A/3B |
| 54 | sealing means | FIG. 3A/3B |
| 55 | cap | FIG. 3A/3B |
| 56 | bottom | FIG. 3A/3B |
| 57 | wire loom | FIG. 3A/3B |
| 58 | top | FIG. 3A/3B |
| 59 | outlet channel | FIG. 3C |
| 60 | screw | FIG. 3C |
| 61 | channel | FIG. 3C |
| 62 | widened end | FIG. 3C |
| 63 | tapered end | FIG. 3C |
| 64 | channel | FIG. 3C |
| 65 | space | FIG. 3D |
| 66 | outlet hole | FIG. 3A/3B |
| 70 | bottom part | FIG. 4 |
| 71 | manchet | FIG. 4 |
| 72 | tube | FIG. 4 |
| 73 | piston | FIG. 4 |
| 74 | piston rod | FIG. 4/5A/6A |
| 75 | inlet check valve | FIG. 4 |
| 76 | outlet check valve | FIG. 4 |
| 77 | hose | FIG. 4 |
| 78 | measuring space | FIG. 4 |
| 79 | measuring space | FIG. 4 |
| 80 | valve connector | FIG. 4 |
| 81 | space | FIG. 4 |
| 82 | central axis | FIG. 4/5A/5B/6A/6B |
| 83 | top part (of gauge | FIG. 5A |
| | assembly) | |
| 84 | bottom part (of gauge | FIG. 5A |
| | assembly) | |
| 85 | handle | FIG. 5A |
| 86 | nipple | FIG. 5A/5B |
| 87 | spring washer | FIG. 5A/6A |
| 88 | spacer | FIG. 5A/6A |
| 89 | nut | FIG. 5A/6A |
| 90 | washer | FIG. 5A/6A |
| 91 | space | FIG. 5A/5B |
| 92 | pneumatic pressure | FIG. 5A |
| | gauge | |
| 93 | nipple | FIG. 5A/6A |
| 94 | S-bend | FIG. 5A |
| 95 | O-ring | FIG. 5A/5B |
| 96 | gland | FIG. 5B |
| 100 | reading point | FIG. 0L |
| 101 | housing | FIG. 0L |
| 102 | manometer | FIG. 0L |
| 103 | piston rod | FIG. 0L |
| 104 | channel | FIG. 0L |
| 105 | top | FIG. 0L |
| 106 | bottom | FIG. 0L |
| 107 | measuring channel | FIG. 0L |
| 108 | measuring point | FIG. 0L |
| 109 | suspension | FIG. 0L |
| 110 | suspension | FIG. 0L |
| 111 | measuring space | FIG. 0L |
| 112 | suspension | FIG. 0L |
| 113 | tube | FIG. 0L |
| 120 | reading point | FIG. 0R |
| 121 | housing | FIG. 0R |
| 122 | gauge | FIG. 0R |
| 123 | piston rod | FIG. 0R |
| 124 | channel | FIG. 0R |
| 125 | wire loom | FIG. 0R |
| 126 | top | FIG. 0R |
| 127 | bottom | FIG. 0R |
| 128 | measuring point | FIG. 0R |
| 129 | suspension | FIG. 0R |
| 130 | measuring space | FIG. 0R |
| 133 | top part (of gauge | FIG. 6A |
| | assembly) | |
| 134 | bottom part (of gauge | FIG. 6A |
| | assembly) | |
| 135 | seal | FIG. 6A |
| 136 | nipple | FIG. 6A/6B |
| 137 | sensor | FIG. 6A |
| 138 | tube | FIG. 6A/6B |

1. A piston-chamber combination comprising an elongate chamber which is bounded by an inner chamber wall and comprising a piston means in said chamber to be sealingly movable relative to said chamber at least between first and second longitudinal positions of said chamber,
said chamber having cross-sections of different cross-sectional areas at the first and second longitudinal positions of said chamber and at least substantially continuously differing cross-sectional areas at intermediate longitudinal positions between the first and second longitudinal positions thereof, the cross-sectional area at the first longitudinal position being larger than the cross-sectional area at the second longitudinal position,
said piston means being designed to adapt itself and said sealing means to said different cross-sectional areas of said chamber during the relative movements of said piston means from the first longitudinal position through said intermediate longitudinal positions to the second longitudinal position of said chamber, wherein the piston means comprises an elastically deformable container comprising a deformable material, wherein the piston means comprises an enclosed space communicating with the deformable container,
characterized by the fact that
the enclosed space has an at least substantially constant volume.

2. A piston-chamber combination comprising an elongate chamber which is bounded by an inner chamber wall, and comprising a piston in said chamber to be sealingly movable relative to said chamber wall at least between a first longitudinal position and a second longitudinal position of the chamber, said chamber having cross-sections of different cross-sectional areas and different circumferential lengths at the first and second longitudinal positions, and at least substantially continuously different cross-sectional areas and circumferential lengths at intermediate longitudinal positions between the first and second longitudinal positions, the cross-sectional area and circumferential length at said second longitudinal position being smaller than the cross-sectional area and circumferential length at said first longitudinal position, said piston comprising a container which is elastically deformable thereby providing for different cross-sectional areas and circumferential lengths of the piston adapting the same to said different cross-sectional areas and different circumferential lengths of the chamber during the relative movements of the piston between the first and second longitudinal positions through said intermediate longitudinal positions of the chamber, the piston is produced to have a production-size of the container in the stress-free and undeformed state thereof in which the circumferential length of the piston is approximately equivalent to the circumferential length of said chamber at said second longitudinal position, the container being expandable from its production size in a direction transversally with respect to the longitudinal direction of the chamber thereby providing for an expansion of the piston from the production size thereof during the relative movements of the piston from said second longitudinal position to said first longitudinal position, wherein the piston means comprises an enclosed space communicating with the deformable container,
characterized by the fact that
the enclosed space has an at least substantially constant volume.

3. A combination according to claim 1, additionally comprising a piston rod, wherein the piston rod is comprising the enclosed space, wherein said enclosed space has a blind end.

4. A combination according to claim 1, wherein said container is inflatable, wherein the inlet of said enclosed space is comprising a check valve.

5. A combination according to claim 1, wherein the combination additionally is comprising a measurement system, wherein the sensor and a gauge are connected by a wire loom, the enclosed space is closed by said wire loom assembly, embedded in a material which is sealing the enclosed space, the gauge being positioned on top of said piston rod.

6. A combination according to claim 5, wherein said material is fitting into a stepped configuration of the hollow piston rod, the step with the smallest diameter being closest to the top of said piston.

7. A combination according to claim 1, wherein the combination additionally is comprising a measurement system comprising a gauge, and an enclosed measuring space where a parameter is being measured, wherein said enclosed space is closed by an O-ring and a tube, wherein the enclosed space is comprising said tube, which is comprising said enclosed measuring space.

8. A combination according to claim 1, wherein the combination additionally is comprising a measurement system comprising a gauge, and an enclosed measuring space in which a parameter is being measured, wherein said enclosed space is closed by a sealing between the gauge housing and said gauge.

9. A combination according to claim 7, wherein the gauge is comprising the sensor, and where the sensor is communicating with the enclosed measuring space.

10. A pump for pumping a fluid, the pump comprising:
a combination according to claim 1,
means for engaging the piston means from a position outside the chamber,
a fluid entrance connected to the chamber and comprising a valve means, and
a fluid exit connected to the chamber.

11. A pump according to claim 10 wherein the engaging means have an outer position where the piston means is at the first longitudinal position of the chamber, and an inner position where the piston means is at the second longitudinal position of the chamber.

12. A pump according to claim 10 wherein the engaging means have an outer position where the piston means is at the second longitudinal position of the chamber, and an inner position where the piston means is at the first longitudinal position of the chamber.

13. A shock absorber comprising:
a combination according to claim 1,
means for engaging the piston means from a position outside the chamber, wherein the engaging means have an outer position where the piston means is at the first longitudinal position of the chamber, and an inner position where the piston means is at the second longitudinal position.

14. A shock absorber according to claim 13, further comprising a fluid entrance connected to the chamber and comprising a valve means.

15. A shock absorber according to claim 13 further comprising a fluid exit connected to the chamber and comprising a valve means.

16. A shock absorber according to claim 13 wherein the chamber and the piston means form an at least substantially sealed cavity comprising a fluid, the fluid being compressed when the piston means moves from the first to the second longitudinal positions of the chamber.

17. A shock absorber according to claim 13 further comprising means for biasing the piston means toward the first longitudinal position of the chamber.

18. An actuator comprising:
a combination according to claim 1,
means for engaging the piston means from a position outside the chamber,
means for introducing fluid into the chamber in order to displace the piston means between the first and the second longitudinal positions of the chamber.

19. An actuator according to claim 18, further comprising a fluid entrance connected to the chamber and comprising a valve means.

20. An actuator according to claim 18, further comprising a fluid exit connected to the chamber and comprising a valve means.

21. An actuator according to claim 18 further comprising means for biasing the piston means toward the first or second longitudinal position of the chamber.

22. An actuator according to claim 18, wherein the introducing means comprise means for introducing pressurised fluid into the chamber.

23. An actuator according to claim 18 wherein the introducing means are adapted to introduce a combustible fluid, such as gasoline or diesel, into the chamber, and wherein the actuator further comprises means for combusting the combustible fluid.

24. An actuator according to claim 18 wherein the introducing means are adapted to introduce an expandable fluid to the chamber, and wherein the actuator further comprises means for expand the expandable fluid.

25. An actuator according to claim 18 further comprising a crank adapted to translate the translation of the piston means into a rotation of the crank.
